(19) United States
(12) Patent Application Publication
(10) Pub. No.: US 2007/0083014 A1
(43) Pub. Date: Apr. 12, 2007

(54) Clearcoat coating composition

(75) Inventors: John E. Boisseau, Bloomfield Hills, MI (US); Donald H. Campbell, Hartland, MI (US); Walter H. Ohrbom, Hartland Township, MI (US); Sergio E. Balatan, West Bloomfield, MI (US); Gregory G. Menovcik, Northville, MI (US)

Correspondence Address: BASF CORPORATION, 1609 BIDDLE AVENUE, MAIN BUILDING, WYANDOTTE, MI, 48192, US

(73) Assignee: BASF CORPORATION, SOUTHFIELD, MI (US)

(21) Appl. No.: 11/538,891

(22) Filed: Oct. 5, 2006

Related U.S. Application Data
(60) Provisional application No. 60/724,716, filed on Oct. 7, 2005.

(51) Int. Cl. C08F 120/02

(52) U.S. Cl. 525/329.7; 525/386; 525/330.3

(57) ABSTRACT

A clearcoat coating composition comprises a vinyl or acrylic polymeric resin prepared by reacting a functional group on a vinyl or acrylic polymer, wherein the polymer has a glass transition temperature (T_{g})≧40° C. as calculated by the Fox equation, with a reactant that provides a curable functional group that is separated from the polymer backbone by at least two alkylene, cycloalkylene, or arylene groups of at least two carbons each long.

### FIELD OF THE INVENTION

The present invention relates generally to clearcoat coating compositions. More specifically the invention relates to a clearcoat coating composition for use in automotive coating applications.

### BACKGROUND OF THE INVENTION

Automotive coating compositions are required to provide good appearance, for example high gloss, and to resist damage imparted by environmental exposure as well as damage from scratch, mar, chip, and damage from exposure to gasoline (gasoline resistance). Environmental regulations continuously require reduced volatile organic content (VOC) of coatings.

The appropriate resin system must be utilized in coatings to achieve these properties. Typically, low T_{g} flexible resins are utilized in coatings to obtain gasoline resistance. Clearcoats having adequate hardness for resistance to damage from scratch and mar, on the other hand, generally utilize a high T_{g} polymeric resin or utilize a high crosslink density in the coating. The high T_{g} resin-containing systems often require higher levels of solvent to provide a coating with adequate spray viscosity and flow to achieve a smooth, glossy appearance. Use of the high T_{g} resins thus results in increased VOC content of the coating, making it difficult to meet the requirements for low VOC. These coatings with good hardness also typically have worse resistance to gasoline, as the high crosslink density or high T_{g} of the resins do not provide enough flexibility to allow the polymer to swell without damage when it is contacted with and absorbs gasoline. Even where lower crosslink density is utilized, for example in a metallic coating, swelling is not uniform and absorption of gas is uneven throughout the clearcoat, causing localized damage and uneven appearance in the coating.

### SUMMARY OF THE INVENTION

The subject invention provides a coating composition, particularly a clearcoat coating composition, that may be used to prepare an automotive composite coating where the clearcoat is applied over at least one basecoat layer. The clearcoat coating composition comprises a vinyl or acrylic polymeric resin prepared by reacting a functional group on a vinyl or acrylic polymer, wherein the polymer has a glass transition temperature (T_{g})≧40° C. as calculated by the Fox equation, with a reactant that provides a curable functional group that is separated from the polymer backbone by at least two alkylene, cycloalkylene, or arylene groups of at least two carbons each long. A curable functional group is a group that undergoes reaction during curing of the coating composition to provide a crosslink, preferably a thermally irreversible crosslink.

These coating compositions provide flexibility in a high T_{g} resin so that the cured coatings obtained from them have the flexibility to accommodate the swelling upon exposure to gasoline and particularly when subjected to the gas soak test as described below without sacrificing the hardness needed for excellent scratch and mar resistance. Coating compositions formulated from these resins also have good sprayability and flow properties for smooth appearance, while maintaining a low VOC content. The coating compositions provide cured coatings with good hardness, etch resistance and resistance to scratch and mar.

### DETAILED DESCRIPTION OF THE INVENTION

A clearcoat coating composition comprises a polymeric resin comprising a backbone derived from ethylenically unsaturated monomers wherein the theoretical T_{g} of the backbone polymer is ≧40° C. as determined by the Fox equation. The backbone polymer has at least one kind of reactive functional group (a) that is reacted with a reactant to provide a curable functional group (b) that is separated from the polymer backbone by at least two alkylene, cycloalkylene, or arylene groups of at least two carbons each. In certain embodiments, the reactive functional groups (a) are the same as the curable functional group (b) separated from the polymer backbone. In such embodiments, a portion of the reactive functional groups (a) may remain following reaction with the reactant. This remaining portion of reactive functional groups (a) would be available for crosslinking during cure of the coating composition. In other embodiments, all of the reactive functional groups (a) are reacted with the reactant, so that none remain. The curable functional groups (b) may or may not be the same type of functional groups as the original reactive functional groups (a). The polymeric resin may also comprise curable functional groups (c) that are not separated from the polymer backbone by at least two groups of at least two carbon atoms each.

The vinyl or acrylic polymeric resins contain a portion of monomer units having no curable functional groups and a portion of monomer units represented by the following structure I: 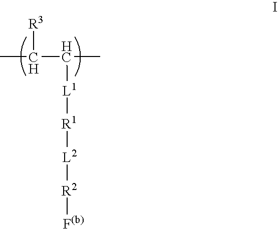
in which R¹ and R² are alkylene, cycloalkylene, or arylene groups, optionally substituted and optionally containing internal heteroatoms such as oxygen, each independently having at least two carbon atoms separating (respectively) L¹ and L² and L² and F^{(b)}; L¹ and L² are linking groups independently selected from the group consisting of ester, ether, urea, and urethane groups; F^{(b)} is the curable functional group (b); and R³ is H or methyl. The monomer units having no curable functional groups may be provided by incorporating into the vinyl or acrylic polymeric resin any copolymerizable monomer that does not contain a curable functional group. The monomer units having essentially no curable functional groups, and thus as essentially non-crosslinkable, comprise at least 45 weight percent and in another embodiment at least 50 weight percent, of the total polymer formulation weight. Essentially non-crosslinkable means that one weight percent or less of any monomer functionality crosslinks during curing of the coating. The monomers that are non-crosslinkable include monomers A′ and A″ wherein A′ monomers have a T_{g} of ≦60° C., as determined by the Fox equation, and are present in the polymer formulation in an amount of ≦10 weight percent, preferably ≦5 weight percent, based on total polymer formulation weight. Examples of these monomers include, but are not limited to, ethyl hexyl methacrylate, ethyl hexyl acrylate, lauryl methacrylate, butyl acrylate, and ethyl acrylate and mixtures of these. A″ monomers have a Tg of >60° C. and include but are not limited to methyl methacrylate, styrene, cyclohexyl methacrylate, isobornyl methacrylate, methacrylic acid and acrylic acid, 2-hydroxyethyl methacrylate and mixtures of these. For example in an acid-epoxy system a non-crosslinkable functionality would be hydroxyl functionality.

The vinyl or acrylic polymer may optionally also contain a portion of monomer units that retain the reactive functional group (a), which may or may not be the same as the curable functional group (b). In a typical embodiment, such monomer units may be represented by the following structure II: 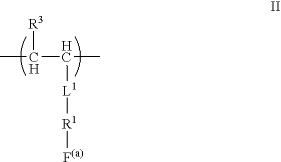
in which R¹, L¹, and R³ are as previously defined and F^{(a)} is the reactive functional group (a). The linking group L¹ may be an ester group, so that the monomer unit arises from polymerization of an acrylate or methacrylate monomer having reactive functional group (a).

The vinyl or acrylic polymer may optionally also contain a portion of monomer units having curable functional group (c), which may or may not be the same as the curable functional group (b). In a typical embodiment, such monomer units may be represented by the following structure III: 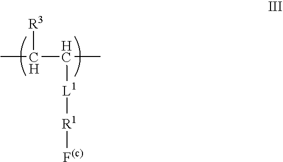
in which R¹, L¹, and R³ are as previously defined and F^{(c)} is the curable functional group (c). The linking group L¹ may be an ester group, so that the monomer unit arises from polymerization of an acrylate or methacrylate monomer having a curable functional group (c).

Monomers containing the reactive functional group (a) are commercially available and are used as provided herein. Such reactive functional groups may include hydroxyl groups, carboxyl groups, carbonate groups, isocyanate groups, epoxide groups, and amine groups. Reactive functional groups (a) may be provided by monomers such as hydroxyethyl methacrylate, hydroxyethyl acrylate, hydroxypropyl methacrylate, hydroxypropyl acrylate, meta-isopropenyl-α,α-dimethylbenzyl isocyanate, (available from American Cyanamid Company, Wayne, N.J. under the trade name TMI), glycidyl methacrylate, 2-carbamate ethyl methacrylate, and the like.

Linking groups L¹ and L² may be selected from the group consisting of ester, ether, urea and urethane groups and mixtures thereof and are formed by reaction of any of the above monomers with a chain extension agent. Examples of chain extension agents include cyclic esters such as epsilon-caprolactone, epoxides such as the glycidyl ester of neodecanote, cyclic anhydrides such as maleic anhydride and succinic anhydride, diisocyanates such as hexamethylene diisocyanate and isophorone diisocyanate, and mixtures thereof. The chain extension reaction can occur before, during or after polymerization. The chain extension results in separating the crosslinking group from the backbone by at least alkylene groups, R¹ and R², that are each at least two carbon atoms in length. The functional group remaining from the reaction is curable functional group (b) or is converted to curable functional group (b) before, during or after polymerization, if required. An example of this would be reaction of the hydroxyl group (as reactive functional group (a)) provided by copolymerization of hydroxyethyl methacrylate with a lactone to provide hydroxyl functional material, followed by reaction with a first isocyanate group of monomeric isophorone diisocyanate and then reaction of the remaining isocyanate group with hydroxy propyl carbamate to provide a carbamate group as the curable functional group (b). Another example of this would include reaction of the hydroxyl group provided by copolymerization of hydroxyethyl methacrylate with one or more molecules of epsilon-caprolactone to provide a hydroxy group as curable group (b). A further example is reaction of an isocyanate group provided by copolymerization of an isocyanate functional monomer, e.g. TMI, with a compound containing both an isocyanate reactive group and an active hydrogen crosslinkable functional group, such as isophorone diisocyanate half-capped with hydroxypropyl carbamate. Polyether extended polyols may also be utilized as the chain extended linking group. Yet another example is reaction of the hydroxyl group provided by copolymerization of hydroxyethyl methacrylate with a cyclic anhydride such as succinic anhydride to provide a carboxyl group as curable group (b).

R¹ and R² are alkylene, cycloalkylene, or arylene groups, optionally substituted, e.g. with halogen atoms, oxygen atoms, or alkyl groups, and optionally containing internal heteroatoms such as oxygen, each independently being at least two carbon atoms in length. R¹ and R² can be the same or different. The curable functional group (b) and optional curable functional group (c) can be the same or different and preferably selected from active hydrogen functional groups, epoxide groups, carboxyl groups, carbonate groups, carbamate groups, isocyanate groups, and actinically curable functional groups, and mixtures thereof, where the curable functional group may be blocked or unblocked. Of the total number of curable functional groups of the polymeric resin, at least about 50% of them are part of a monomer unit of structure I, preferably at least about 60%, and more preferably at least about 70%. All curable functional groups can be part of a monomer unit of structure I, or the polymeric resin may have further curable functional groups that are a part of a monomer unit of structure II and/or of structure III.

The polymer may have an equivalent weight (based on curable functional groups) of between 300 and 900, and preferably between 450-750. The weight average molecular weight (M_{w}) of the polymer may be between 2000 Daltons and 12,000 Daltons, and in some preferred embodiments may be between 2000 and 6000 Daltons. The T_{g} of the polymer is at least 50° C. based on the Fox Equation.

The vinyl or acrylic polymer is utilized in an amount between about 20 and about 90 weight percent and in one embodiment between about 35 and 65 weight percent based on total solids weight of the film-forming resins (the vehicle).

The coating further comprises at least one crosslinking resin to react with the curable functional groups on the vinyl or acrylic polymer. Suitable cross-linking agents include, but are not limited to, aminoplast resins, such as a melamine formaldehyde resins, isocyanate cross-linking agents, blocked isocyanate cross-linking agents, polyacid or anhydride cross-linking agents, polyepoxide crosslinking agents, and mixtures of these.

The crosslinking resin is utilized in an amount between about 10 and about 40 weight percent based on total solids weight of the vehicle and in one embodiment between 10 and 35 weight percent based on total solids weight of the vehicle.

As understood by those skilled in the art, an aminoplast resin is formed by the reaction product of formaldehyde and amine where the preferred amine is a urea or a melamine. Although urea and melamine are the preferred amines, other amines such as triazines, triazoles, diazines, guanidines, or guanamines may also be used to prepare the aminoplast resins. Furthermore, although formaldehyde is preferred for forming the aminoplast resin, other aldehydes, such as acetaldehyde, crotonaldehyde, and benzaldehyde, may also be used.

The aminoplast resin is selected from the group of melamine-formaldehyde resins having a methylol group, an alkoxymethyl group, or both. Examples of suitable aminoplast resins include, but are not limited to, monomeric or polymeric melamine-formaldehyde resins, including melamine resins that are partially or fully alkylated using alcohols that preferably have one to six, more preferably one to four, carbon atoms, such as hexamethoxy methylated melamine; urea-formaldehyde resins including methylol ureas and siloxy ureas such as butylated urea formaldehyde resin, alkylated benzoguanimines, guanyl ureas, guanidines, biguanidines, polyguanidines, and the like. Monomeric melamine formaldehyde resins are particularly preferred.

Although not necessarily preferred, an alternative cross-linking agent for use in the subject invention is a polyisocyanate cross-linking agent. The most preferred polyisocyanate cross-linking agent is a diisocyanate. The polyisocyanate cross-linking agent can be an aliphatic polyisocyanate, including a cycloaliphatic polyisocyanate, or an aromatic polyisocyanate. The term “polyisocyanate” as used herein refers to any compound having a plurality of isocyanate functional groups on average per molecule. Polyisocyanates encompass, for example, monomeric polyisocyanates including monomeric diisocyanates, biurets and isocyanurates of monomeric polyisocyanates, extended poly-functional isocyanates formed by reacting one mole of a diol with two moles of a diisocyanate or mole of a triol with three moles of a diisocyanate, and the like. Aliphatic polyisocyanates are preferred when the coating composition is used as an automotive topcoat composition. Useful examples include, without limitation, ethylene diisocyanate, 1,2-diisocyanatopropane, 1,3-diisocyanatopropane, 1,4-butylene diisocyanate, lysine diisocyanate, 1,4-methylene bis(cyclohexyl isocyanate), isophorone diisocyanate, toluene diisocyanate, the isocyanurate of toluene diisocyanate, diphenylmethane 4,4′-diisocyanate, the isocyanurate of diphenylmethane 4,4′-diisocyanate, methylenebis-4,4′-isocyanatocyclohexane, isophorone diisocyanate, the isocyanurate of isophorone diisocyanate, 1,6-hexamethylene diisocyanate, the isocyanurate of 1,6-hexamethylene diisocyanate, 1,4-cyclohexane diisocyanate, p-phenylene diisocyanate, triphenylmethane 4,4′,4″-triisocyanate, tetramethyl xylene diisocyanate, and metaxylene diisocyanate.

The curable coating composition may also optionally include additional polymeric resins such as polyester or polyurethane resins. These resins may be utilized in amounts between about 0 and about 50% weight percent based on total coating solids weight.

The curable coating composition may also include one additive or a combination of additives. Such additives include, but are not limited to, solvents, catalysts, hindered amine light stabilizers (HALs), ultra-violet absorbers (UVAs), rheology control agents, anti-yellowing agents, adhesion promoting agents, and the like. Specific examples of some of the above additives include organic solvents such as n-methyl pyrrolidone and oxo-hexyl acetate as solvents to effect such characteristics as pop and sag resistance, and polybutyl acrylate, fumed silica, and silicone as rheology control agents. In certain embodiments, it is preferred for the curable coating composition to be a solventborne clearcoat coating composition, the most preferred additives then are HALs and UVAs. For instance, various organic solvents including, but not limited to, aromatic solvents such as xylene and toluene, esters such as butyl acetate and amyl acetate, alcohols such as propanol and isobutanol, n-methyl pyrrolidone, ketone such as methyl isobutyl ketone and methyl propyl ketone, which may be included to modify the solids content and viscosity of the polymer. Catalysts such as di-methylaminopyridine (DMAP), para-toluene sulfonic acid, dinonylnaphthalene disulfonic acid, and metal catalysts such as dibutyl tin dioxide, may be used to enhance cure response of the coating composition. Anti-oxidants including, but not limited to, tri-isodecyl phosphite, and anti-yellowing agents including, but not limited to, sodium borohydride may also be used as desired. The additives may be used in the coating composition with the polymer and crosslinking agent in combinations.

In a one embodiment, said coating is a clearcoat coating composition. The clearcoat is preferably used as in a composite coating for automotive applications. The coating composition can be applied onto many different types of substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, primer surfacer, and/or basecoat, cured or uncured.

Articles, such as automotive body panels and the like, may be coated by a method for coating such articles that is disclosed in the present invention. This method includes the steps of applying onto the article the curable coating composition as described above, and curing the curable coating composition to form a coated article. The coating composition can be applied in one or more passes to provide a film thickness after cure of typically from about 20 to about 100 microns. The curable coating composition is most preferably spray-applied onto the article by methods that are known in the art including, but not limited to, rotary and air-atomized spray processes. The curable coating composition is reacted or ‘cross-linked’ at temperatures where the cross-linking agent reacts with the group of the polymer to form the coated article having a cured film of the curable coating composition. The crosslinking may be done at temperatures ranging from 100° C. to 175° C., and the length of cure is usually about 15 minutes to about 60 minutes. Preferably, the coating is cured at about 120° C. to about 150° C. for about 20 to about 30 minutes. Heating can be done in infrared and/or convection ovens.

In one embodiment, the coating composition is utilized as the clearcoat of an automotive composite color-plus-clear coating. The pigmented basecoat composition over which it is applied may be any of a number of types well-known in the art, and does not require explanation in detail herein. Polymers known in the art to be useful in basecoat compositions include acrylics, vinyls, polyurethanes, polycarbonates, polyesters, alkyds, and polysiloxanes. Preferred polymers include acrylics and polyurethanes. In one preferred embodiment of the invention, the basecoat composition also utilizes a carbamate-functional acrylic polymer. Basecoat polymers may be thermoplastic, but are preferably crosslinkable and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally elevated temperatures. Useful crosslinkable functional groups include hydroxy, epoxy, acid, anhydride, silane, and acetoacetate groups. Preferred crosslinkable functional groups include hydroxy functional groups and amino functional groups.

Basecoat polymers may be self-crosslinkable, or may require a separate crosslinking agent that is reactive with the functional groups of the polymer. When the polymer comprises hydroxy functional groups, for example, the crosslinking agent may be an aminoplast resin, isocyanate and blocked isocyanates (including isocyanurates), and acid or anhydride functional crosslinking agents.

The clearcoat coating composition of this invention is generally applied wet-on-wet over a basecoat coating composition as is widely done in the industry. The coating compositions described herein are preferably subjected to conditions so as to cure the coating layers as described above.

It is to be understood that all of the preceding chemical representations are merely two-dimensional chemical representations and that the structure of these chemical representations may be other than as indicated.

The following examples illustrating the formation of and the use of the acrylic polymer of the present invention, as presented herein, are intended to illustrate and not limit the invention.

### EXAMPLES

Resin Preparation

To 1003.5 parts of Shellsol A100 aromatic solvent, sold by Shell, is heated to 140° C. under an inert atmosphere is added over a four hour period a mixture of 306.3 parts of hydroxypropyl methacrylate, 235.6 parts styrene, 829.3 parts of isobornyl methacrylate, 42.4 parts acrylic acid, 706.8 parts of neodecanoic acid, 2,3-dihydroxypropyl ester, 2-methyl-2-propenoate, 235.6 parts of e-caprolactone and 157.7 parts of a 50% solution of t-butyl peracetate in odorless. Then 95.4 parts of Shellsol A100 is added and the reaction mixture held at 140° C. for 90 minutes. The reaction mixture is then lowered to 110° C. and a mixture of 29.4 parts of t-butyl perethylhexanoate and 61.2 parts of Shellsol A100 is added over a one hour period. Then 81.6 parts of Shellsol A100 is added and the reaction mixture is held at 110° C. for one hour. The final resin has a Tg of 52° C., and a hydroxy equivalent weight of 560 g/equ. The weight average molecular weight (Mw) will be between 4500 and 5700 Daltons.

Coating Composition Example

All percentages are weight percent

| | |
|---|---|
| 54.3% | Resin of the Invention per above example |
| 7.3% | High Imino Methylated Melamine |
| 9.2% | fumed silica dispersed in acrylic resin |
| 3.7% | UV absorber |
| 0.7% | Hindered Amine Light Stabilizer |
| 0.2% | Silicone Surfactant |
| 0.1% | Polyacrylate flow additive |
| 0.2% | Acid Catalyst |
| 9.3% | Blocked Polyisocyanate |
| 2% | Exxate 1000 Solvent |
| 13% | n-Butanol |

The invention has been described herein with reference to particular embodiments. It should be understood, however, that variations and modifications can be made within the spirit and scope of the disclosure.

What is claimed is:

1. A coating composition, comprising a vinyl or acrylic polymeric resin prepared by reacting
(a) a reactive functional group on first a vinyl or acrylic polymeric resin having a (T_{g})≧40° C. as calculated by the Fox equation with
(b) a reactant that provides a curable functional group that is separated from the polymer backbone by at least two alkylene, cycloalkylene, or arylene groups of at least two carbons each in length, wherein said alkylene, cycloalkylene, or arylene groups are optionally substituted and optionally comprise internal heteroatoms.

2. The coating composition according to claim 1, wherein the vinyl or acrylic polymeric resin comprises at least 45 weight percent of monomer units having essentially no curable functional groups.

3. The coating composition according to claim 2, wherein the monomer units having essentially no curable functional groups consist of ≦10 weight percent of monomers A′ that have a Tg of ≦60° C. and the balance A″ monomers that have a Tg of ≧60° C.

4. The coating composition according to claim 1, wherein the vinyl or acrylic polymeric resin further comprises curable functional groups other than those provided by the reactant of (b).

5. The coating composition according to claim 4, wherein the curable functional groups other than those provided by the reactant of (b) are different functionality from those provided by the reactant of (b).

6. The coating composition according to claim 4, wherein the curable functional groups other than those provided by the reactant of (b) are the same functionality as those provided by the reactant of (b).

7. The coating composition according to claim 4, wherein the curable functional groups provided by the reactant of (b) are at least about 50% of the total number of curable functional groups of the vinyl or acrylic polymeric resin.

8. The coating composition according to claim 1, wherein the coating composition is a clearcoat coating composition.

9. A coated article comprising a cured layer of the coating composition according to claim 1.

10. A coated article comprising a cured layer of the coating composition according to claim 9 over a basecoat layer.

11. A clearcoat coating composition, comprising a vinyl or acrylic polymeric resin, said resin comprising at least 45% by weight of monomer units having no curable functional groups and a portion of monomer units represented by the following structure I: 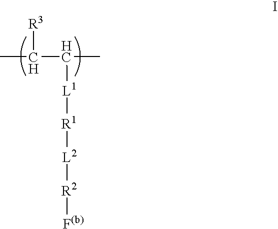
wherein R¹ and R² are independently selected from alkylene, cycloalkylene, or arylene groups that have two or more carbon atoms in length, optionally substituted and optionally containing internal heteroatoms such as oxygen; L¹ and L² are linking groups independently selected from the group consisting of ester, ether, urea, and urethane groups; F^{(b)} is a curable functional group; and R³ is H or methyl.

12. A clearcoat coating composition according to claim 11, wherein the monomer units having no curable functional groups comprise up to 10 weight percent of monomer units having T_{g} of ≦60° C.

13. A clearcoat coating composition according to claim 11, wherein the vinyl or acrylic polymeric resin further comprises monomer units represented by the following structure III: 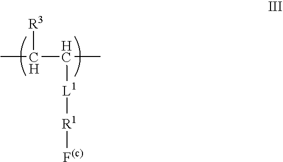
in which R¹, L¹, and R³ are as previously defined and F^{(c)} is a curable functional group.

14. A clearcoat coating composition according to claim 13, wherein F^{(c)} is the same kind of functional group as F^{(b)}.

15. A clearcoat coating composition according to claim 13, wherein at least about 50% of the total number of curable functional groups of the polymeric resin are F^{(b)} groups.

16. A coated article comprising a cured layer of the clearcoat coating composition according to claim 11.

17. A coated article comprising a cured layer of the coating composition according to claim 16 over a basecoat layer.

18. A clearcoat coating composition comprising a vinyl or acrylic polymer having a T_{g} of at least 50° C. and having curable functional groups that are separated from the polymer backbone by at least two linking groups independently selected from the group consisting of ester, ether, urea and urethane groups.

19. A clearcoat coating composition according to claim 18, wherein each linking group is separated by at least two carbon atoms from each other linking group.

20. A clearcoat coating composition according to claim 18, wherein the polymer comprises at least 45% by weight of monomer units having no curable functional groups.

21. A clearcoat coating composition according to claim 18, wherein at least about 50% of the total number of curable functional groups are the curable functional groups that are separated from the polymer backbone

22. An article comprising a cured layer of the clearcoat coating composition according to claim 18.
